(19) United States
(12) Patent Application Publication
(10) Pub. No.: US 2006/0181758 A1
(43) Pub. Date: Aug. 17, 2006

(54) Spatial light modulator

(76) Inventor: Thomas E. Willis, Mountain View, CA (US)

Correspondence Address: TROP PRUNER & HU, PC, 1616 S. VOSS ROAD, SUITE 750, HOUSTON, TX, 77057-2631, US

(21) Appl. No.: 11/057,489

(22) Filed: Feb. 14, 2005

(51) Int. Cl. G02B 26/00

(52) U.S. Cl. 359/238

(57) ABSTRACT

Spatial light modulators may have their yields improved by providing redundant address lines. If one address line is defective, the other address line may be utilized. Power may be reduced by only writing data to a memory associated with the array when the data that is to be displayed is sufficiently different from the data for a particular pixel that already has been displayed.

### BACKGROUND

This invention relates generally to spatial light modulators.

A projection display system typically includes one or more spatial light modulators (SLMs) that modulate light for purposes of producing a projected image. The SLM may include, for example, a liquid crystal display (LCD) such as a high temperature polysilicon (HTPS) LCD panel or a liquid crystal on silicon (LCOS) microdisplay, a grating light valve or a MEMs (where “MEMs” stands for micro-electro-mechanical devices) light modulator such as a digital mirror display (DMD) to modulate light that originates from a lamp of the projection display system. In typical projection display systems, the lamp output is formatted with optics to deliver a uniform illumination level on the surface of the SLM. The SLM forms a pictorial image by modulating the illumination into spatially distinct tones ranging from dark to bright based on supplied video data. Additional optics then relay and magnify the modulated illumination pattern onto a screen for viewing.

The SLM typically includes an array of pixel cells, each of which is electrically controllable to establish the intensity of a pixel of the projected image. In some projection display systems, SLMS are transmissive and in others, they are reflective. For the purposes of simplification, the discussion will address reflective SLMs. An SLM may be operated so that each pixel has only two states: a default reflective state which causes either a bright or a dark projected pixel and a non-default reflective state which causes the opposite projected pixel intensity. In the case of an LCOS SLM, the pre-alignment orientation of the LC material and any retarders in the system determine whether the default reflective state is normally bright or normally dark. For the purposes of simplification, the discussion will denote the default reflective state as normally bright, i.e., one in which the pixel cell reflects incident light into the projection lens (the light that forms the projected image) to form a corresponding bright pixel of the projected image. Thus, in its basic operation, the pixel cell may be digitally-controlled to form either a dark pixel (in its non-default reflective state) or a bright pixel (in its default reflective state). In the case of a DLP SLM, the states may represent the pixel in a co-planar position to the underlying substrate.

Although its pixels are operated digitally, the above-described SLM may also be used in an application to produce visually perceived pixel intensities (called “gray scale intensities”) between the dark and bright levels. For such an application, each pixel may be controlled by pulse width modulation (PWM), a control scheme that causes the human eye to perceive gray scale intensities in the projected image, although each pixel cell still only assumes one of two states at any one time. The human visual system perceives a temporal average of pixel intensity when the PWM control operates at sufficiently fast rates.

The spatial light modulator may be comprised of an array of pixel cells that may be addressed. Each pixel cell is part of a rectangular grid or array. Each cell may be uniquely addressed by a pair of address lines. The failure of either of these address lines may result in yield loss of the entire device. Unfortunately, the failure of one relatively minor address line may result in the loss of a relatively complicated part.

Thus, there is a need for ways to reduce losses of yield in spatial light modulators and, particularly, losses due to defective address lines.

### BRIEF DESCRIPTION OF THE DRAWINGS

FIG. 1 is a schematic depiction of a projection display in accordance with one embodiment of the present invention;

FIG. 2 is a schematic depiction of the spatial light modulator of FIG. 1 in accordance with one embodiment of the present invention;

FIG. 3 is a schematic depiction of the spatial light modulator array shown in FIG. 2 in accordance with one embodiment of the present invention;

FIG. 4 is a flow chart for one embodiment of the present invention;

FIG. 5 is a schematic depiction of still another embodiment of the present invention; and

FIG. 6 is a flow chart for the embodiment shown in FIG. 5 in accordance with one embodiment of the present invention.

### DETAILED DESCRIPTION

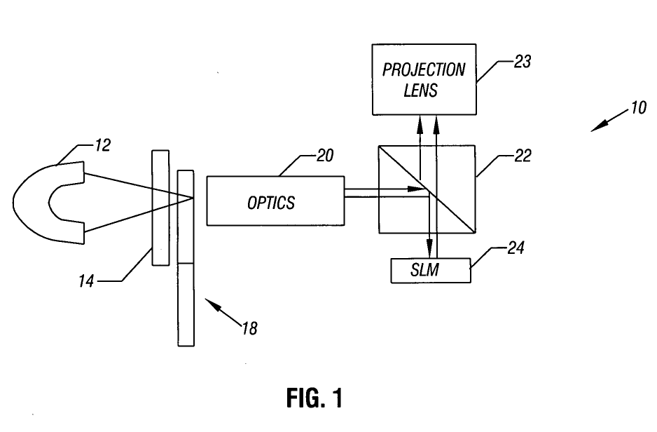

Referring to FIG. 1, a projection display system 10 in accordance with an embodiment of the invention includes one or more spatial light modulators (SLMs) 24 (one shown in FIG. 1) that modulate impinging light to produce a projected composite, color optical image (herein called “the projected image”). The SLM 24 may be a liquid crystal (LC) SLM, a tilt-mirror SLM, or a MEM-type SLM, as two examples. Unless otherwise stated, embodiments described herein use LC SLMs for purposes of simplifying the description. However, it is understood that other SLMs, such as grating light valve, HTPS, or other technology SLMs, may be used, in other embodiments of the invention. Furthermore, unless otherwise noted below, the projection display system 10 includes a single SLM 24, for purposes of simplifying the following description, although other projection systems that have multiple SLMs may be alternatively used and are within the scope of the appended claims.

In accordance with some embodiments of the invention, the projection display system 10 includes a lamp 12 (a mercury lamp, for example) that produces a broad visible spectrum illumination beam that passes through an ultraviolet/infrared (UV/IR) filter 14 of the system 10. The light passing from the filter 14, in turn, passes through a rotating color wheel 18.

As previously stated, the single-SLM configuration that is depicted in FIG. 1 is for purposes of example only. Thus, the projection display system 10 may be replaced by another projection display system, in other embodiments of the invention, such as a projection display system that includes three SLMs, one for each primary color (red, green and blue, for example) of the projected image. As another example, in some embodiments of the invention, red, green and blue light may be temporally shared on an SLM in a two SLM display projection system. Therefore, many variations are possible and are within the scope of the appended claims.

Referring to FIG. 1, among its other components, the projection display system 10 includes homogenizing and beam shaping optics 20 that further shape and collimate the light that exits the color wheel 18, prepolarizes and directs the resultant beam to the polarizing beam splitter 22. The polarizing beam splitter (PBS) 22 separates the light from the color wheel 18 based on polarization. More specifically, assuming the single-SLM configuration described above, the polarizing beam splitter 22 directs the different color sub-bands of light (at different times) to the SLM 24. Once modulated by the SLM 24, the polarizing beam splitter 22 directs the modulated beam through projection lenses 23 for purposes of forming the projected image.

The SLM 24 may be a digital mirror device (DMD), liquid crystal display (LCD) device, or other pixelated SLM. In some embodiments of the invention, the SLM 24 is a liquid crystal on silicon (LCOS) device that includes a liquid crystal layer that is formed on a silicon substrate in which circuitry (decoders, control circuits and registers, for example) to control and operate the device is fabricated.

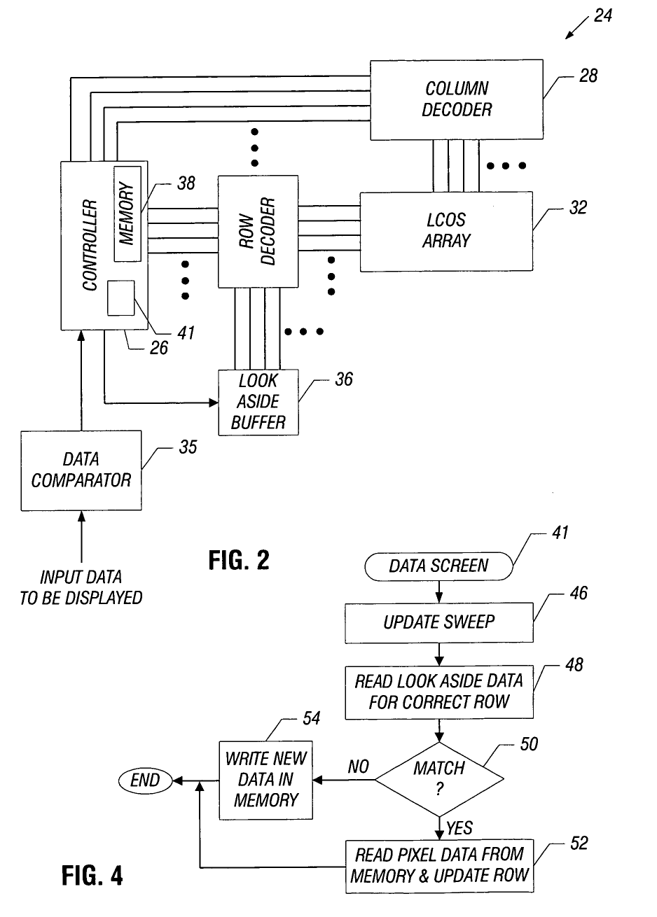

Referring to FIG. 2, the spatial light modulator 24 may include a controller 26 which may, in one embodiment, be a programmable device such as a microcontroller. In other embodiments, it may be a hard wired device. The controller 26 provides control signals to a column decoder 28 and a row decoder 30. An array 32 of pixel cells which, in one embodiment, may be a liquid crystal-on-silicon (LCOS) array, is addressed by address lines emanating from the column decoder 28 and the row decoder 30. In this way, each pixel cell (not shown) in the array 32 may be uniquely addressed.

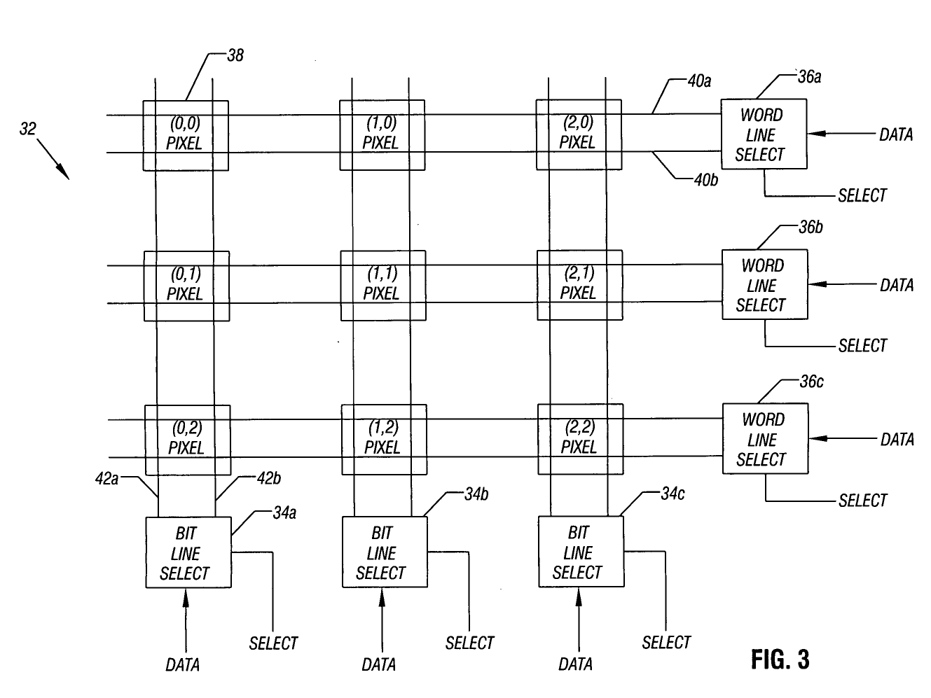

Referring to FIG. 3, a portion of the array 32 may include a gridwork of pixel cells 38. Each pixel cell 38 may be coupled to four address lines, two of the address lines being redundant. Thus, if the vertical address lines are referred to as bit lines, a pair of redundant bit lines 42a and 42b may be provided for each cell in the column. Likewise, if the horizontal address lines are referred to as word lines, each cell 38 in the array 32 may be coupled to a pair of redundant word lines 40a and 40b. Only one of the redundant pair of address lines is used at any time. If an address line 42a or 40b is defective, rather than discarding the entire part, the redundant address line 42b or 40b may be used in its place.

The selection of a redundant bit line 42b may be done by a bit line selector 34a-34c and the selection of a redundant word line 40b may be selected by a redundant word line selector 36a-36c. Thus, during electrical tests, if it is determined that one of the address lines 42a, 40a is defective, that address line may be located and its redundant address line 42b, 40b may be activated in its stead. The selection of the redundant word or bit line may be done by the word line selectors 36 or bit line selectors 34. Each of the selectors 34 or 36 may be coupled to and may be part of a row or column decoder 30 or 28. After the data for a given row or column is selected, a bit line selector or word line selector may be provided in the data flow.

If it is determined during electrical tests that one of the bit lines or word lines is defective, the redundant bit line or word line may be selected by applying the select signal. In one embodiment, the select signal may program a programmable bit or a fuse. Thus, in one embodiment, the redundant address line is permanently programmed so that once the user receives the spatial light modulator 24, it always uses the good address line and the bad address line is never utilized. As a result, the yield of the displays 32 may be increased, reducing the cost of those parts.

In some embodiments, it may be possible to reduce the number of times that a memory associated with the spatial light modulator 24 must be updated. This reduces power consumption and possibly improves performance in some embodiments. In this regard, in FIG. 2, the controller 26 includes a memory 38 and a memory 41 storing software. The controller 26 receives data from a data comparator 35. That data comparator 35 provides an output signal to indicate whether any given address line, such as a row at a particular location corresponding to a column, has data which does not require any change in the display.

In such case, the data for the particular location may be read from the memory 38 using the previous data as the input. In this way, it is not necessary to write new data for that location into the memory 38, reducing the number of memory accesses.

More particularly, referring to FIG. 4, the data screening software stored in the memory 41 initiates an update sweep command 46. Progressive locations are then read from a look aside buffer 36. These locations are identified based on the data from the data comparator 35. Namely, if the new data to be displayed for a particular location is not significantly different or is the same as the previous data for that location, that location may be stored in the look aside buffer 36.

As indicated in block 48, the buffer 36 is read. If there is a match for a particular array 32 location, as determined in diamond 50, the data for that pixel may be read from the memory 38. Thus, instead of writing new data into the memory 38 for that pixel, the previous data, in terms of intensity, is simply reused. This eliminates a memory write operation.

Conversely, if there is no match, then, as indicated in block 54, the new data must be written into the memory 38 for eventual display on the SLM 24.

In some embodiments, only if the pixel value for a given pixel is identical is it not updated. However, in other embodiments, if the difference from a previous pixel is below a given threshold, the previous value may be simply reused.

In one embodiment, the look aside buffer 36 is a per row n-bit vector that identifies which pixel values appear in the row. The value of n depends on the specific implementation. For example, in a system with an eight-bit pixel value, n might be 256. In this case, bit i of the vector for a given row is one if the row contains a pixel value of i, and otherwise it is zero.

With smaller values of n, each bit may correspond to a range of pixel values. That is, the bit i may imply that the pixels of value v are less than a given vector V₁ and greater than another vector V₂. With the look aside information, the spatial light modulator 24 may reduce power consumption by reducing the number of memory writes

Conventionally, very wide accesses may be undertaken to a memory to retrieve pixel values that are used to determine how to drive the digital pulse width modulation waveforms. For example, a device may scan through the pixel array in a row sequential order, updating the pulse width modulation waveforms for an entire row in parallel. To support this operation, the device is also scanning through a pixel value memory array in row sequential order to provide data that the system can use to determine the pulse width modulation waveform. Such an organization requires a very wide memory interface that can consume significant power.

One approach to reduce the power is reduce the number of bits of memory that must be read in any given cycle to support the modulation. The pixel values tend to exhibit spatial locality. That is, a pixel value at a given pixel is likely to be similar to the values of its neighbors. By encoding that similarity with the pixel value for a given pixel, one can disable reads as necessary. This encoding can be in-band, by reserving some number of pixel values, or out-of-band, by adding per pixel bits to indicate similarity.

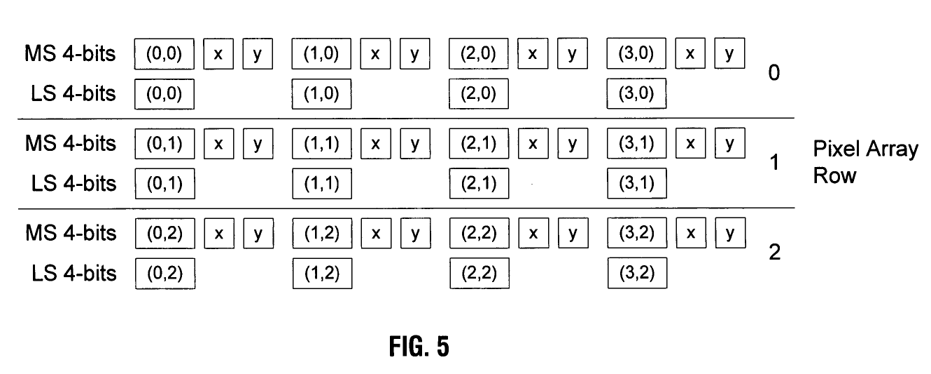

Referring to FIG. 5, for a simple, illustrative 4×3 pixel array, each memory row contains one nibble (in the illustration, 4 bits) of the pixel value (in this illustration, 8 bits). Thus, to read the entire pixel value requires a reading of two rows, one devoted to more significant bits and the other devoted to less significant bits. In most embodiments, only most and least significant bits may be used. An initial per pixel bit (x, y) may be provided to reduce the number of read operations. For a pixel at x, y, the x and y bits indicate that the pixels at (x−1, y) and (x, y+1) share the same more significant nibble, respectively. That is, when these bits are set, the device reads only the more significant nibble of (x, y), using this value as the more significant nibble of (x−1, y) and (x, y+1). For example, for the more significant bit (1, 1), this would involve using its value for bits (0, 1) and (1, 2).

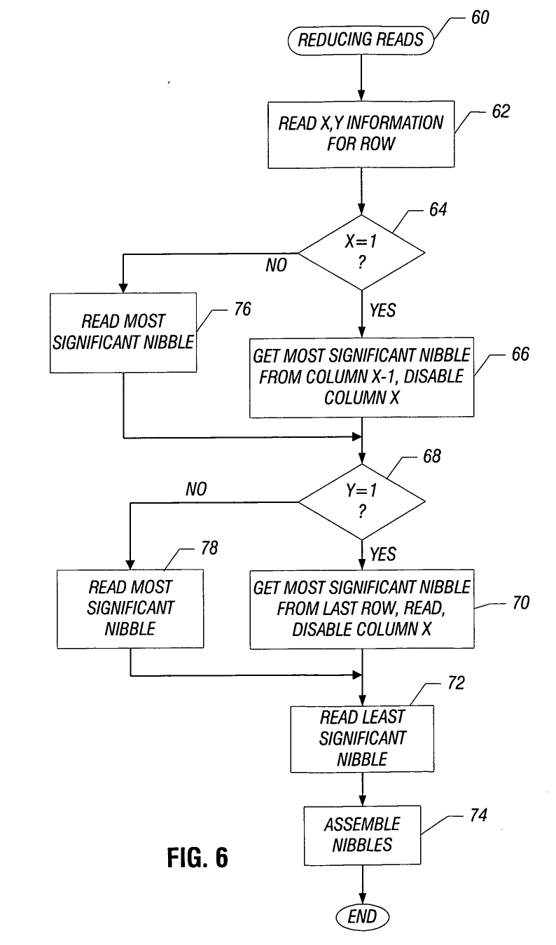

Thus, referring to FIG. 6, software 60 for reducing reads may be stored in association with any memory of the system including the memories 38 and 41 shown in FIG. 2. Initially, the x, y information is read for a row as indicated in block 62. Then, at diamond 64, the flow determines whether the x bit is one. If so, the more significant nibble is selected from the column x−1 as indicated in block 66. During the upcoming more significant nibble read, the column x is disabled.

If the bit y is one, the system uses the more significant nibble from the last row that was read as indicated in block 66. During the upcoming more significant nibble read, the column x is again disabled.

If either the x or the y bits are zero, the device reads the more significant nibble in each case (see blocks 76 and 78). Otherwise, the device reads the less significant nibble as indicated in block 72. The device assemblies the more and less significant nibbles (from neighbors) and updates as appropriate as indicated in block 74.

The system may use the x or the y bit, but not both. In other embodiments, a given column may stand in for multiple adjacent columns instead of just one as in this example. The x and y bits may be set by collecting the pixel values for two rows and performing the appropriate comparisons between elements of the two row buffers.

By setting the x and y bits appropriately, the device can steer around failures. For example, if there is a failure in the more significant bits in row y, the y bit in row y−1 may be set to allow it to stand in for the failing bits in row y. Under some circumstances this may cover for the failure in row y.

In some embodiments, this approach enables savings and power consumption, as well as improving fault tolerance in the memory.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
indicating when the value for a bit in a storage is to be used as the value for a nearby bit in a spatial light modulator.

2. The method of claim 1 including enabling two nearby bits to assume the same value as said bit.

3. The method of claim 1 including using a pixel value in a first bit as the pixel value in two nearby bits.

4. The method of claim 3 including using the value of the first bit for two nearby bits including a bit in an adjacent row and a bit in an adjacent column.

5. The method of claim 4 including using the pixel values from said first bit as the pixel values for an adjacent bit in an adjacent row and an adjacent bit in an adjacent column.

6. The method of claim 1 including storing information about when to replace bits in a pixel memory.

7. The method of claim 1 including using a comparison of the pixel values of nearby bits with a first bit to determine whether to replace the pixel values of said nearby bits with the pixel value of said first bit.

8. The method of claim 7 including replacing those pixel values when those pixel values differ from the pixel value of said first bit within a given threshold.

9. A spatial light modulator comprising:
an array of pixel cells; and
a data comparator to determine whether new pixel data to be written to a pixel cell is substantially similar to a previous pixel data of said cell and, if so, to indicate that the previous pixel data should be used in place of the new pixel data.

10. The modulator of claim 9 including a controller, said data comparator coupled to said controller.

11. The modulator of claim 9 including a look-aside buffer to store said previous pixel data.

12. The modulator of claim 9 wherein said data comparator to determine whether new pixel data is identical to the previous data and, if so, to indicate the use of the previous pixel data in place of the new pixel data.

13. The modulator of claim 12 including a buffer to store the results of the comparison by said data comparator.

14. The modulator of claim 9 including a controller to control writes to the array, said controller to allow the new pixel data to be written to the display only when the new pixel data is sufficiently different from the previous pixel data.

15. A spatial light modulator comprising:
an array of pixel cells; and
a device to determine when the value of a first pixel cell may be used as the value for a nearby pixel cell.

16. The modulator of claim 15 wherein said device to enable two nearby pixel cells to assume the same value as said first pixel cell.

17. The modulator of claim 16 wherein said device to enable a first nearby pixel cell in the same row as said first pixel cell and a second nearby pixel cell in the same column as said first pixel cell to have the same values as said first pixel cell.

18. The modulator of claim 15 wherein said device to compare a pixel value for a nearby pixel cell to a pixel value for said first pixel cell to determine whether to write a new pixel value to said nearby pixel cell or simply use the pixel value of said first pixel cell.

19. The modulator of claim 18 wherein said device to use a threshold to determine whether to replace pixel values.

20. A projection display comprising:
a spatial light modulator including an array of pixel cells and a device to determine when the value of a first pixel cell may be used as the value for a nearby pixel cell; and
a beam splitter to provide light to said spatial light modulator receive light from said spatial light modulator.

21. The display of claim 20 wherein said device to enable two nearby pixels to assume the same value as said first pixel cell.

22. The display of claim 20 wherein said device to use a threshold to determine whether to replace pixel values.
